(19) United States
(12) Patent Application Publication
(10) Pub. No.: US 2024/0067161 A1
(43) Pub. Date: Feb. 29, 2024

(54) ADAPTIVE VEHICLE SYSTEMS REACTIVE TO CHANGING TERRAIN

(71) Applicant: FORD GLOBAL TECHNOLOGIES, LLC, Dearborn, MI (US)

(72) Inventors: Brendan F. Diamond, Grosse Pointe, MI (US); Keith Weston, Canton, MI (US); James Stevens, Belleville, MI (US); David Guglielmo, Northville, MI (US)

(21) Appl. No.: 18/387,295

(22) Filed: Nov. 6, 2023

Related U.S. Application Data
(63) Continuation of application No. 17/240,312, filed on Apr. 26, 2021.

(51) Int. Cl. B60W 30/02; B60W 30/14; B60W 40/06; G01C 21/34

(52) U.S. Cl. CPC B60W 30/02; B60W 30/143; B60W 40/06; G01C 21/3453; B60W 2556/45

(57) ABSTRACT

A vehicle determines a surface deviance on a road ahead of the vehicle and towards which the vehicle is traveling. The vehicle determines an adjustment to an adaptive ride-height system of the vehicle to change a vehicle ground-clearance, the adjustment determined based at least on a dimension associated with the deviance and, prior to reaching the deviance, adjusts the adaptive ride-height system in accordance with the determined adjustment.

### CROSS-REFERENCE TO RELATED APPLICATIONS

This application is a continuation of U.S. application Ser. No. 17/240,312, filed Apr. 26, 2021, the disclosure of which is hereby incorporated in its entirety by reference herein.

### TECHNICAL FIELD

The illustrative embodiments generally relate to adaptive vehicle systems that are reactive to changing terrain.

### BACKGROUND

Many performance vehicles have very low ground clearances that can result in at least minor damage when driven on uneven terrain. While roadways are generally considered to be “even” terrain, a variety of road conditions can create unsuitable driving environments for such vehicles. Potholes, loose rocks, road damage, etc. can all create possible damaging events for these vehicles.

Additionally, many parking lots and neighborhoods have speed bumps installed, which can also create possible minor collision opportunities. Drivers of such vehicles have learned to be cautious to avoid damage, but in certain conditions, such as at night, some of the problem areas can be virtually impossible to see. While drivers can control their speed significantly in parking lots, for example, it is not usually recommended to drive at 25 mph on a highway, for example, and an unexpected pothole can do real damage to a low ground-effect.

Some potholes and other obstructions have even gotten so bad that vehicles with “common” clearances may suffer minor damage or worse from impacting the potholes. Uneven concrete and asphalt can also present issues, even for the vehicles with standard clearances. Drivers who want to travel in areas with bad roads are forced to accept this risk as a risk of travel, and most drivers do, since the damage is often cosmetic. Nonetheless, many of the vehicles, especially the performance vehicles, tend to have high costs of repair, and even cosmetic damage can run into the thousands of dollars for repair.

### SUMMARY

In a first illustrative embodiment, a system includes a processor, of a vehicle, enabled to determine a surface deviance on a road ahead of the vehicle and towards which the vehicle is traveling. The processor is further enabled to determine an adjustment to an adaptive ride-height system of the vehicle to change a vehicle ground-clearance, the adjustment determined based at least on a dimension associated with the deviance and, prior to reaching the deviance, adjust the adaptive ride-height system in accordance with the determined adjustment.

In a second illustrative embodiment, a system includes a processor, of a vehicle, enabled to determine a route to a destination from a present location of the vehicle. The processor is enabled to determine instances of surface deviances, along the route, prior to reaching one or more of the surface deviances, based on data indicating surface deviances along the route. The processor is further enabled to determine, for each instance of surface deviance, an adjustment to an adaptive ride-height system of the vehicle and a corresponding trigger location, and, responsive to the vehicle reaching a given trigger location, adjusting the adaptive ride-height system to change vehicle clearance in accordance with the determined adjustment corresponding to the given trigger location.

In a third illustrative embodiment, a system includes a processor, of a vehicle, enabled to determine that a vehicle has reached a trigger location assigned for surface deviance impact mitigation based on a vehicle location compared the to the trigger location stored in memory along with a corresponding mitigation action. The processor is also enabled to automatically adjust a vehicle control system in a manner predefined as the mitigation action with respect to the trigger location to mitigate an effect of a known surface deviance on the vehicle as it travels over the surface deviance. Further, the processor is enabled to revert the adjusted vehicle control system to a state of the system when the adjustment was made for the known surface deviance, responsive to the vehicle passing a location associated with the known surface deviance system;

### BRIEF DESCRIPTION OF THE DRAWINGS

FIG. 1A shows an illustrative example of a vehicle having an adaptive ride height systems;

FIG. 1B shows an illustrative example of a roadway heatmap;

FIG. 2 shows an illustrative process for surface deviance detection;

FIG. 3 shows an illustrative deviance verification process;

FIG. 4 shows an illustrative process for route planning;

FIG. 5 shows an illustrative geo-fencing or trigger creation process;

FIG. 6 shows an illustrative alert processing process; and

FIG. 7 shows an illustrative alert distribution process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments propose vehicles that have adaptable ride height adjustment, which can provide temporary clearance for obstructions and impediments. While the vehicle may not be intended to be driven at the increased ride height for an overlong period, for a variety of engineering reasons, temporarily lifting the vehicle may not present significant issues and may avoid many common ground-level minor incidents. Because the systems are adaptive, they can utilize known locations of impediments and obstructions to react to a situation and revert when the situation passes. Wireless communication capability in the vehicles means that even recently detected impediments and trouble spots can be quickly disseminated to vehicles in the area of the impediment and those vehicles may still have an opportunity to avoid incident. Crowd-sourced data gathering can allow for a vast repository of such locations to be accumulated quickly, and even updated to remove certain locations once the threat of incident has passed (e.g., road repair has occurred).

Municipal offices may also benefit from such information, which can help them prioritize repairs without having to wait for sufficient drivers to complain about a location. The frequency with which local vehicles are forced to adapt to speed bumps can lead to better graded speed bumps or fewer bumps in certain areas where drivers tend to drive lower vehicles.

When a vehicle cannot adapt or cannot adapt sufficiently, warnings can prevent drivers from contacting the impediments at full speed, or even allow for impediment avoidance. Vehicles can even go so far as to automatically limit speeds if an interaction with an impediment is unavoidable and if the driver desires the vehicle to have such control. Using features similar to adaptive cruise control, a vehicle approaching an unavoidable impediment can control or recommend a slow down strategy that does not create issues for other traffic, but also mitigates the impact of the impediment to the object vehicle. In other instances, such drivers may simply choose to route around an unavoidable impediment, once they are aware of its existence.

Data gathered by vehicle sensors such as cameras, suspensions, RADAR, LIDAR, accelerometers (to detect changes in vehicle attitude), etc. can be used to build heatmaps for roadways and parking lots that define topography for the road surface. Road surface topography can be tuned to a given vehicle model and feature set (e.g., wheel size, known clearance, etc) to generate customized adaptation strategies for a given vehicle make or model, or even a given vehicle equipped in a certain manner. Drivers may be responsible for informing the system of after-market parts that may affect a calculation, but even those parts can be accommodated within reason. Tuning can also account for known vehicle dip on inclines and when turning.

Geofences or other digital markers can indicate trouble spots for a given vehicle or model, and can be generated on-the-fly for a new route or even be included in updateable map data. Communication of new trouble spots can result in immediate trigger generation (e.g., geo-fence or other conditional) for affected vehicles (e.g., vehicles on-route through the location or within proximity to the location) and allow vehicles adapt to a changed condition very quickly. This could be especially useful if, for example, a semi blows a tire and the debris is scattered across the roadway, including some larger elements. An SUV driving over the debris (clearing it) can still register the debris and communicate the information to a performance vehicle traveling towards the debris. While this may not result in perfect mapping of the debris field in a limited window of time, it can still give the other driver time to react in some manner, which can decrease the likelihood of a costly incident. The semi itself may even be capable of detecting the blown tire and broadcasting the location at which it occurred, which can give a cursory notice to affected drivers that debris of a likely X size (an average or typical max size, for example) is likely to be encountered at or around that location.

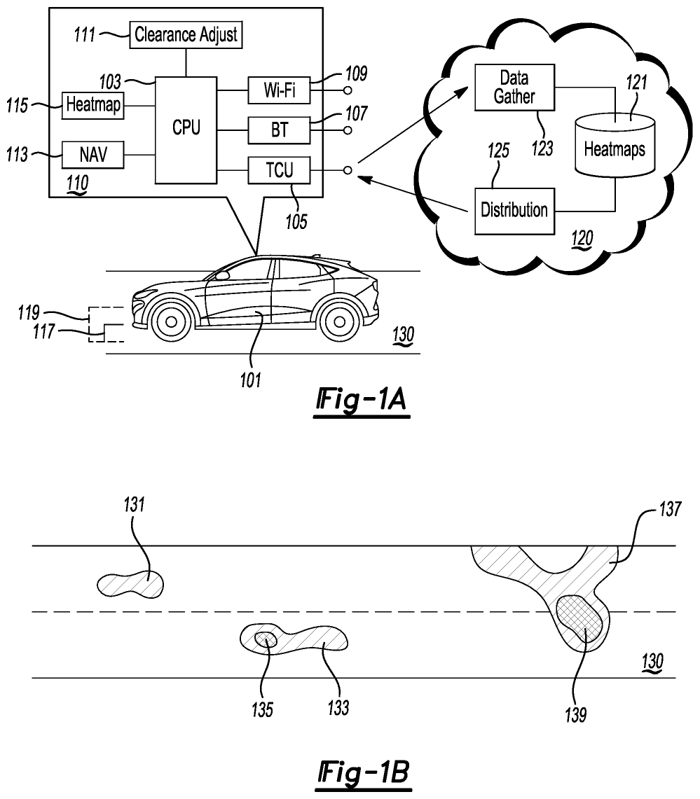

FIG. 1A shows an illustrative example of a vehicle having an adaptive ride height system. This is an example of a vehicle 101 having a low clearance 117 that can be adjusted to a higher clearance 119 based on an active ride height adjustment system.

The vehicle 101 includes an onboard computing system 110 including various software applications, electronic control units (ECUs) and other components. While various modules are described as elements of this system, they can be combined or omitted as appropriate for a given configuration.

One or more onboard processors 103 can evaluate a clearance situation and control the ride height for adjustable vehicles and/or issue alerts and speed controls as necessary. A telematics control unit (TCU) 105, BLUETOOTH transceiver 107 and Wi-Fi 109 can provide for onboard communication with remote vehicles and systems, such as those in the cloud 120. A memory may store one or more applications and data sets, such as a clearance adjustment application or evaluator process 111 (the actual clearance adjustment may be done by an ECU in communication with other vehicle hardware) which may work in conjunction with a heatmap dataset 115 and a navigation unit 113 to determine instances where clearance should be adjusted or warnings should issue.

If the heatmap 115 indicates that a roadway 130 includes an impediment, the navigation unit can indicate when a vehicle 101 is approaching the impediment and the clearance evaluator 111 can determine what changes to the vehicle 101 clearance should occur. In some examples, some or all of this processing can be done offboard in the cloud 120, and the relevant decision points can be passed back to the vehicle 101 through a distribution process 125. The distribution process 125 can disseminate known heat map data sets stored in a database 121, as well as push information about newly discovered impediments to a vehicle 101. If evaluation is done in the cloud, the process 125 can also send adaptation instructions and triggers, such as geo-fences, where the adaptation should occur when the navigation unit 113 determines that a vehicle 101 has crossed a geo-fence.

The vehicle 101 can also use a variety of sensors (not shown) to gather information about roadway 130 as it travels. Active feedback systems can determine road unevenness, as well as vehicle yaw, pitch and roll. Cameras, RADAR and LIDAR, for example, can detect the presence of impediments even if not directly contacted by the vehicle 101. This information can be reported to the cloud data gathering process 123 for evaluation and storage in the database 121. The information may also be distributed to other local vehicles through BLUETOOTH or Wi-Fi communication, for example. The information may also be sent to infrastructure units, such as dedicated short range communication (DSRC) transceivers to store the information locally and distribute it to other passing vehicles which may not be in direct communication with the reporting vehicle 101.

FIG. 1B shows an illustrative example of a roadway heatmap. This is a basic example of a heatmap showing two possible terrain deviations. The “///” deviation is a shallower deviation and the “XXX” deviation is a deeper deviation. On this illustrative roadway 130, there is one instance of a shallow dip at 131. The dip at 133 includes a deeper portion at 135. If a vehicle 101 cannot handle the deeper dip 135, the vehicle 101 may be routed to avoid the lower lane, even though encountering the shallower dip 131 may still be likely. The larger pothole 137 includes a deep portion 139 that spans both lanes, and so vehicles 101 that cannot adapt to the deeper pothole 139 may be routed around this region or given an aggressive warning if approaching this location at speed, since they cannot avoid the deep part of the hole except by driving on the shoulder (which may still be preferable to impacting the hole 139).

Other vehicles, with adaptable systems, may have their ride heights adjusted when approaching the hole 137 and this may persist until the vehicle passes the hole 131, depending on the real distance between impediments. Any driver, in an adaptable vehicle or otherwise, may be alerted to the presence of the potholes if they desire, because this information may be useful even to drivers who have performance SUVs that can handle the holes with ease.

FIG. 2 shows an illustrative process for surface deviance detection. In this example, the process detects a deviance in the road at 201. This can be detected, for example, by a suspension system engaging, LIDAR, RADAR, cameras, accelerometers indicating unexpected movement about an axis (e.g., yaw, pitch, roll), or other suitable vehicle system that determines that a vehicle has encountered a terrain change that is a deviance from level. If the change is not above a threshold at 203, e.g., the change appears to be a small deviance, the process may still send the data to the cloud 120 at 205, in case other data can be used to verify the data or it adds to an existing data set.

For example, a first vehicle may have encountered deep pothole 139 in the lower lane in FIG. 1B. This would have been reported and stored, and the recommendation system may believe that a vehicle can avoid this pothole by taking the upper lane. The dip in 137 may not be as significant, but may still be worth recording because the information can be combined with the known information about pothole 139 to determine the full size of the pothole. As more vehicles report, even small deviances, the shape of various impediments can be better mapped out, and evasive maneuvering and required clearance recommendations can improve. Accordingly, even though not shown here, it may also be reasonable to collect sensor data for certain deviances that are not above a threshold.

Vehicles likely have sufficient storage space to store a reasonable amount of sensor data onboard, but the cost of transferring this data to the cloud may be high in the aggregate. Accordingly, the vehicle 101 may always gather sensor data about any deviances as at 207, but may only send the data upon request or if the deviance is above a certain threshold. So, for example, the vehicle 101 encountering 137 but not 139 may gather the data and report the coordinates of the deviance to the cloud at 205. The cloud may confirm that this appears to connect to 139, and so request the more complete sensor data, with which the vehicle 101 can respond at 209. If the vehicle 101 encountered 139, it may have sent the data regardless of request, since that hole may be sufficient to warrant immediate attention. If the vehicle 101 did not receive the request for data over a certain time period, including waiting until memory starts to fill if desired, the vehicle 101 could discard the additional sensor data. While not the only way to perform this embodiment, this version can avoid sending too much information for mere cracks in the road, for example, and can keep data costs down if that is a concern for a given implementation.

If sufficient memory exists, the vehicle 101 can store all the gathered sensor data and transmit it when a cost-free connection exists, such as over a home Wi-Fi network once the vehicle 101 is in a garage. If the memory starts to fill, the vehicle 101 can prioritize the data based on a number of factors, which can include at least an estimated severity of deviance (for deviances whose sensor data has not yet been reported). That would at least preserve a good deal of information about the potential worst “little” deviances. Other prioritization strategies are also possible, for example, a vehicle 101 could be instructed by the cloud 120 to preserve information on areas where limited data currently exists, in order to more completely fill in information for those areas more quickly.

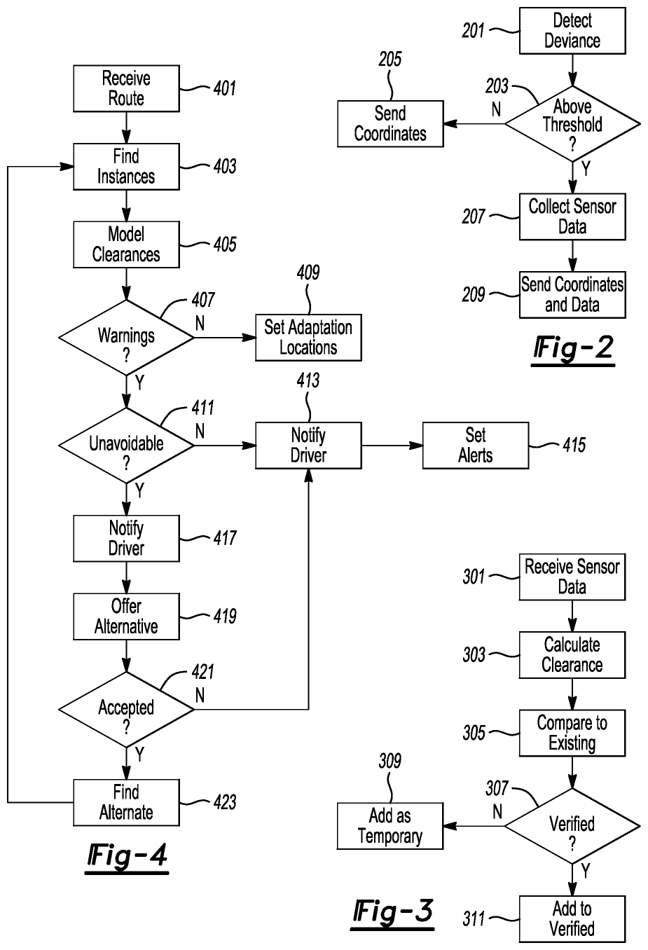

FIG. 3 shows an illustrative deviance verification process. This process could take place onboard the vehicle or in the server, as with any process disclosed herein when reasonable. If a connected mobile device serves as supplemental computing power for the vehicle 101, such processes could also take place on the mobile device.

Here, the process receives sensor data and/or an indicator of a deviance at 301. The process calculates the clearance required for the deviance, and/or calculates the extent of the deviance (size, width, breadth, depth, etc.) as possible from the included sensor data. Some vehicles 101 may have more robust sensing than others, so the calculations can be based on what data is available for a given report. This determined information is then compared to any existing information about the location 305. Since a deviance may extend beyond a single coordinate point, and because GPS coordinates, for example, have a margin of error associated therewith, the comparison may accommodate for an area around a previously reported deviance. Thus, even if reported coordinates are off from an existing set, those coordinates may be: a) map-matched (e.g. moved to a closest road if they indicate off-road and the vehicle 101 is expected to be on-road); and b) given a threshold radius for comparison purposes. If the data matches previously reported deviances, in terms of location at least, if not size and shape, the process may consider the location (and/or size/shape, etc., depending on what matches) verified at 307.

Unverified data may be saved in a repository for comparison at 309, where it can be used for comparison to later-reported data, and verified data may be added to a data-set about the deviance at 311. Unverified data can still be used for planning purposes, the verification step is not necessary and simply can serve to reinforce the existence of, and continuity of, a given deviance. Data about a deviance may include both verified and unverified components (e.g., the location matches, but the size or other characteristic is outside expected bounds based on previous reporting). Unverified elements can later be verified (e.g., a second vehicle also reports the same size or other characteristic) and verified elements can be added to the data-set with higher confidence.

FIG. 4 shows an illustrative process for route planning. In this example, existing data can be used to determine when a vehicle 101 should adapt ride height (assuming the vehicle 101 has such functionality) and when the vehicle 101 should change speed or avoid an area altogether if possible. Recommendations for a given model that has an optional ride-height adjustment can be delivered as ride-height adjustment recommendations (if the process does not know if the specific vehicle 101 has ride height options added on) and the vehicle 101 can handle these as avoidance or slow-down recommendations if it lacks the necessary systems for height adjustment.

In this example, the process receives a route at 401, or can consider an upcoming stretch of road for a vehicle on a single road (e.g., a highway) or a radius of roads in a given proximity to a vehicle 101 if traveling on roads with intersections. For the map-data set considered, the process can find any known instances of deviances at 403. This consideration may have a threshold applied thereto, which is representative of an expected no-incident clearance for a given model, for example, or may consider all deviances. These thresholds can be defined as relevancy parameters that may be stored in a vehicle memory, defining a deviance characteristic and whether a deviance lacking the given characteristic should be ignored.

If the threshold is applied at 405, the system may ignore (for recommendation purposes) deviances that the vehicle 101 should easily accommodate (e.g., an SUV traveling over cracked pavement with medium-sized loose stones). That same pavement, however, may result in a warning for a low-clearance performance vehicle, but the system can consider the impact of the incidents of deviance on a given model at 405 to determine if warning states exist at 407.

If the vehicle 101 can clear the expected deviances without issue, either with or without adaptive ride height, the process may set any necessary adaptations at 409. This would be suitable for, for example, a vehicle 101 where every model includes ride height adaptation, although any warnings generated may still issue to that vehicle 101 where appropriate. Relevancy parameters can also include, for example, a current route, and/or minimum dimensions of a deviance (e.g., height, depth, width, etc.). For the route parameter, the deviance is relevant, for example, if it is located along the route. For the dimensional parameters, the deviance is relevant, for example, if the deviance has a known dimension above a minimum set by a given parameter (e.g., deeper than a minimum depth determined to affect the vehicle). More than one parameter can be considered, so that even if a deviance is along a route, it may still be “irrelevant” if it dimensionally unimpactful.

If there are warnings, such as a vehicle 101 that may not be able to clear a deviance or a vehicle 101 that may require adaptation, but where the adaptation is an add-on and the process does not know if the given vehicle 101 is capable of adaptation, the process can determine if any impact is likely unavoidable at 411. An “unavoidable” impact may include, for example, a location where clearance is insufficient, or is insufficient with height adjustment, and/or where travel on a road (as opposed to a shoulder) will result in encountering the location with a high likelihood or near certainty.

If the route does not include any unavoidable instances, e.g., the vehicle 101 could change lanes to avoid an instance that cannot be accommodated by adaptation, the process may notify the driver 413 that such instances exist and alert the driver to watch for navigation alerts as the driver approaches such locations so that the driver can take the correct path around the incidences. The process may also set alerts at 415, which can be geo-fenced or other triggered alerts to let the driver know to slow, change lanes, etc. when encountering one of the noted incidences of deviance. Alerts can also include route-around instructions, such as a last-exit ramp or turn prior to a deviance, where the driver can take a temporary alternative route around the deviance (e.g., exit highway and re-enter a mile later). When setting these alerts, the process can confirm that the noted exit or turn leads to a road that eventually leads back to where the route indicates the driver is going, at some point after the deviance.

If there are unavoidable incidences of deviance on a route (e.g., pothole 137/139 that spans the whole road), where the vehicle 101 cannot avoid the whole deviance, or at least a relevant portion of the deviance the vehicle is not expected to fully clear, the process may notify the driver at 417 and offer a route-around at 419. The route around can be a new route or a simple avoidance by moving over to an adjoining road and avoiding the deviance. Whether or not a vehicle can clear a deviance can be a projected clearance with a tolerance, so that the system may indicate an unavoidable deviance even if there is a small likelihood the vehicle 101 can clear or navigate around the deviance. This can be implemented as the threshold for clearance or unavoidability if the implementer wants to build in a tolerance to avoid near-misses and false-positives on avoidance. Further, since few deviances will be perfectly mapped, at least initially, and since others may have moving components (e.g., rock-spill on a road), this can help avoid a misprojection of clearance based on a change in conditions or unknown aspect of the deviance.

If the user accepts an alternative route at 421, the process can formulate an alternative at 423 and check the new segments for deviances. Another option is to only formulate the route based on clearance parameters for the vehicle 101, to only consider streets that are “warnings” at best. If the driver does not want a new route, the process can prepare the warnings and possible even add a more aggressive notification since impact with the deviance is projected. The vehicle 101 speed can even be automatically controlled over the deviance if desired, so that the deviance is impacted at a projected reasonable speed.

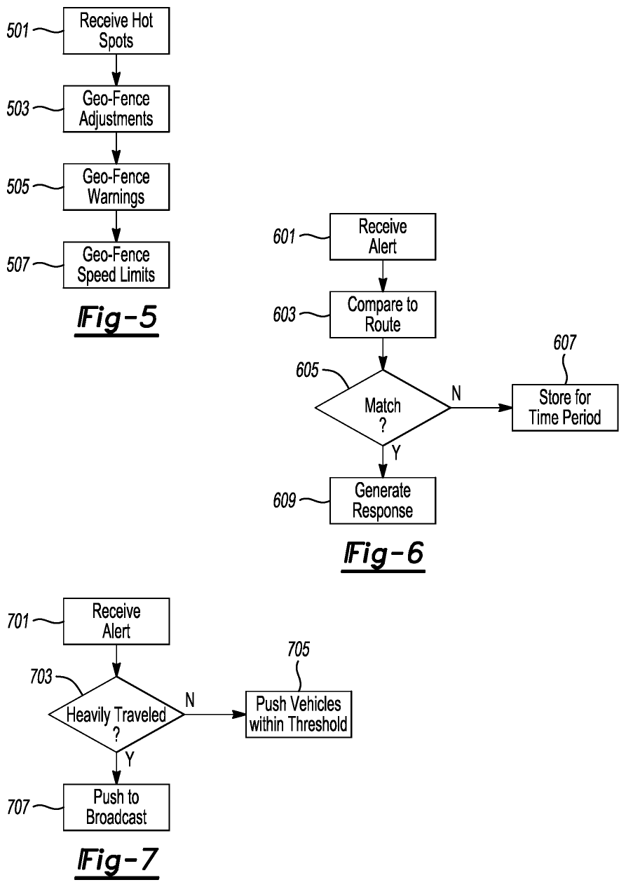

FIG. 5 shows an illustrative geo-fencing or trigger creation process. In this example, the process designates a plurality of different geo-fences along a route based on what sort of conditions are projected to occur. The geo-fences (or other triggers, e.g., enters road, enters highway, etc.) can cause a change to vehicle 101 state, which can include ride height adjustment, vehicle alerts or even vehicle speed control. Each fence can have a recommended or preferred action associated therewith, as well as an alternative action.

For example, each fence may have a warning and an offer to automatically control speed if appropriate. In another vehicle 101, the driver may have opted for automatic speed control and this will be associated with the fence as a default option, with an override option presented (or enabled as a function of the driver manipulating brakes and/or accelerator). The process receives the identifies hot-spots where a relevant deviance is expected at 501. Again, this could be all deviances or simply deviances that were relevant to the clearance of a given vehicle. A driver who frequently drinks coffee while driving, for example, may still want to know of certain deviances even if the vehicle 101 will easily clear them, in order to avoid taking a sip of coffee as the vehicle 101 rumbles through a pothole.

The vehicle 101 creates the geo-fences or triggers relating to adjustments at 503. These can be multi-state triggers, for example, if a vehicle 101 is traveling under X mph then the trigger may not occur to raise the ride height, depending on the deviance and the given clearance under varied ride heights. When the vehicle 101 encounters one of these geo-fences on a route, which can be determined by comparing current coordinates to the geo-fence, the appropriate ride-height adjustment can occur. Similar triggers can exist for reverting to a standard ride height and overlapping fences may be joined into a single fence to avoid triggering a reversion in a new fenced zone.

The process may also geo-fence warnings at 505, which can trigger and/or persist while a vehicle is within a fence where it may encounter a deviance in terrain. As noted, these can be tuned to a vehicle's characteristics and/or driver preferences, and may include multiple fences as well, which can, for example, trigger an initial alert to change lanes sometime in the next X feet to avoid a deviance, and could include a second alert that the deviance will be encountered in Y feet (less than X) to let the driver have a more complete sense of what is going to happen and when. There may also be a condition associated with one or both fences, such as speed. Another conditional, whether the driver is in the correct lane to avoid a deviance, may be used to trigger the closer-proximity alert, which may be more aggressive in nature (louder, brighter, etc.) when the driver is in the incorrect lane (which may be unavoidable in heavy traffic) and which may include a secondary recommendation to slow down in that instance. If the driver is in the correct lane, a warning to stay in that lane for Y feet may occur as an alternative to the encounter warning, and the warning may shift to the encounter warning if the driver changes to the incorrect lane while in the fence and ahead of the deviance. Warnings may also let a driver know when it is safe to resume lane changes or speed as well.

Speed limits, including recommended and automatic speed control, may be geo-fenced as well at 507, especially when a certain speed is projected to be necessary to clear a deviance or mitigate an unavoidable encounter. For example, a vehicle approaching a speed bump at high speed may strike the bump with a ground-effect, but at a lower speed the vehicle 101 may be able to ease over the bump without contact. Other vehicles may be able to navigate a pothole with minimal damage at a low speed, but may suffer at least significant cosmetic damage if they strike the pothole at a speed limit or faster.

If a driver desires, the vehicle 101 can use adaptive cruise control or a similar feature to slow the vehicle 101 in a controlled manner that is reactive to surrounding traffic, which may be preferable to a driver aggressively braking at the last second. Other drivers may want their own control, and may simply want warnings about recommended speeds. The warnings can also indicate the likely safest path if there is one (e.g., avoidance may be achieved by traveling on the uppermost (right-most in most countries) side of the road 130 to avoid 139) and or may become more aggressive in nature if a driver is well above a recommended speed or is in very close proximity to an unavoidable encounter. Speed control can include limiting the ability of the vehicle to travel above the recommended speed until the vehicle passes a location associated with the surface deviance.

An aggressive warning can be different in kind from a standard warning in terms of size, brightness, font, use of audible features, etc. Drivers may even be able to set different actions for different drivers who can be identified by a vehicle (via connected device corresponding to driver, face recognition or other known techniques). For example, a parent may want direct control over speed, but may want a teenage driver to have automatic speed control imposed, and/or automatic avoidance via re-routing when possible and reasonable. Reasonableness of a re-route can be defined by a user—e.g., no more than X minutes or Y miles out of the way, or defined by an OEM as a baseline. Routes with a high likelihood of significant unavoidable impact (e.g., a vehicle with 8 inch clearance cannot avoid a 1 foot deep pothole) may be blocked for certain drivers and presented with significant warnings for others.

FIG. 6 shows an illustrative alert processing process. In this example, the process is capable of handling alerts received in real-time, such as alerts about a new condition. This can be useful if, for example, new debris is on a roadway, a pothole worsens, or other clearance-related events occur in real time. Road construction can sometimes result in significant bumps and dips as the old asphalt is removed, and these events, while not instantaneous in effect, may not exist in any database when a vehicle 101 first encounters them. Rock spills, semi-tire blowouts, load spillage, etc., may result in temporary deviances that can have significant impact on drivers who are unaware of them. By allowing vehicles to report to other vehicles, to roadside DSRC and other infrastructure units, and to a central cloud 120 that can broadcast new incidents, the impact of such occurrences can be mitigated.

If a vehicle 101 receives an alert at 601, the process can take several illustrative steps to determine the relevance. In certain instances, the source of the alert, which can be determined from the message or context included in the message, may be useful to determine the immediate relevance. For example, a vehicle 101 receiving a BLUETOOTH broadcast from another vehicle must be within BLUETOOTH range (unless ad-hoc V2V networking is used) and so the alert is highly relevant in terms of proximity. If the alert indicates that a transmitting-vehicle heading and speed are similar to the receiving vehicle, then the transmitting vehicle 101 is probably on the same road in the same direction as the receiving vehicle. The vehicle 101 could consider this a high priority alert and, for example, immediately slow speed (if safe) on the off-chance full mitigation action cannot be taken. The decision to slow a speed could be tied to a current speed, since a vehicle moving at 70 mph will have much less time to react to something imminent than a vehicle moving at 25 mph. Slowing speed will typically at least mitigate some impact of an encountered deviance.

Assuming there is not an immediate “emergency” mitigation action, the process can compare the received alert to a current route at 603. This sort of comparison may be more useful for alerts received via long-range communication (e.g., cellular or from a Wi-Fi network where the originator is not immediately proximate to the vehicle). A broadcasting vehicle 101 can send the information via BLUETOOTH, DSRC and cellular, if desired, whereby the BLUETOOTH transmission quickly reaches proximate vehicles, the DSRC transmission can be quickly conveyed longer distances along the road preceding the deviance, and the cellular transmission can result in a cloud-broadcast to any vehicles that may eventually be impacted.

If the deviance lies along a planned route at 605, for which fences or triggers have already been set, the process can generate a response at 607 in the form of the appropriate fence or trigger for the occurrence. This can include offering route-arounds or speed-controls, and generally the deviance (if sufficiently ahead of a current location) can be handled as any other. The same logic can apply to deviances that are missing, i.e., the deviance is expected but not encountered, so that vehicles can remove fences as debris is cleared or potholes are filled.

If the vehicle 101 is not projected to encounter the deviance, it may still store the data for some time period at 607, in case a driver deviates from a route or the route changes. If the distribution of these types of real-time notification is such that it primarily reaches vehicles that might be impacted, most receiving vehicles have at least a chance of encountering the deviance if something changes, prior to the deviance becoming a permanent or temporary part of the larger data set used for route planning.

FIG. 7 shows an illustrative alert distribution process. In this example, a cloud server determines some distribution characteristics for a newly encountered deviance or a deviance whose properties have significantly changed enough to warrant an update. The server receives the data at 701 relating to the new/changed deviance, the data indicating that this deviance is not recorded in a present-state in the larger data set (e.g., the server is notified that this is an alert for some form of distribution).

If the new deviance is part of a heavily traveled route at 703, where a significant number of vehicles may be immediately responsive to the information, and may want the information immediately, the server could push the information for an immediate broadcast at 707. The broadcast could be over a cellular network and have a header designating relevant coordinates (e.g., if a vehicle outside the coordinates receives the message, it is not as critical for handling) or the broadcast could be done, for example, via an ATSC network covering the area of note.

ATSC is a broadcast using a vehicle ATSC receiver, and so any equipped vehicle in the broadcast radius will receive the broadcast. This is a useful way to mass-deliver information quickly, and the aforementioned header or similar sorting information could be included to allow individual vehicles to determine how to handle the data. HD Radio and other similar broadcast mediums can also be used to broadcast such alerts, wherein the relevance to a vehicle 101 can be determined based on information included in the broadcast and determined by the vehicle 101 upon receiving the broadcast.

In other instances, such as a low volume road or backroad, the server may not have access to a suitable broadcast medium that covers the area, or may project that few enough vehicles 101 will be in the area to make it more reasonable to directly convey the information to each vehicle 101. If the server knows or can approximate vehicle locations, the information can be directly conveyed to all vehicles (having telematics equipment or network connections) within the relevant proximity. This can include vehicles known to have routes running through the relevant coordinates, vehicles whose ownership location indicates proximity, vehicles reporting locations proximate to the relevant coordinates, etc. Each of those vehicles 101 can then self-determine the relevance of the information to their given travel plans and/or based on where the vehicle is currently located. Again, this information may eventually make its way into a permanent repository, and so the broadcasting and/or transmission may be useful more to serve an immediate need. The need for broadcast can be accommodated based on how long it typically takes to add the data and distribute it through the main process. That is, the scope of the broadcast/delivery, the speed of delivery, etc. can be tuned based on the significance of the deviance, the number of projected impacted drivers, the delay associated with adding the data to a repository, etc.

For example, if data was generally added once three vehicles 101 confirmed the data and this data was disseminated to any new vehicle routes after five minutes, then vehicles projected to be within 5 minutes of travel+the time it typically takes for confirmation would need the data before they could be expected to receive the data under “normal” protocol. Confirmation times would likely be low in heavily traveled areas and high in lightly traveled areas, and so the transmission radius could be tuned accordingly (e.g., vehicles within 6 minutes travel in high traffic areas, vehicles within 20 minutes travel in low traffic areas). Any vehicle outside these radii could be reasonably expected to receive the confirmed data prior to encountering the deviance, for example, via the “normal” protocol relevant to this example (which is not a proposed standard, but rather an example of a standard plan).

For very impactful deviances (e.g., a truck spills a load of rocks all across a highway) the process may expand the radius to ensure that possibly affected vehicles receive the data, and/or may both broadcast the data widely and attempt to deliver the data directly to as many vehicles as possible within a tighter radius who may be immediately impacted. Those vehicles can then take immediate mitigation steps as appropriate.

The illustrative embodiments allow for an improved driving experience by improving the ability of certain vehicles to adapt to changing terrain conditions and by providing guidance and alternatives for vehicles incapable of adapting. This can diminish the impact of terrain deviance across a wide swath of vehicles and allow drivers to proceed along possibly damaging routes with increased confidence that their vehicles can adapt to any changing circumstances.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system comprising:
a processor, of a vehicle, enabled to:
determine a surface deviance on a road ahead of the vehicle and towards which the vehicle is traveling;
determine an adjustment to an adaptive ride-height system of the vehicle to change a vehicle ground-clearance, the adjustment determined based at least on a dimension associated with the deviance; and
prior to reaching the deviance, adjust the adaptive ride-height system in accordance with the determined adjustment.

2. The system of claim 1, wherein the surface deviance is determined based on detection of the deviance indicated by a sensor of the vehicle and wherein data from the sensor further indicates one or more dimensions associated with the deviance.

3. The system of claim 1, wherein the surface deviance is indicated in data stored in vehicle memory and has coordinates associated therewith indicating the presence of the deviance at a location on the road ahead of the vehicle and wherein the data further indicates one or more dimensions associated with the deviance.

4. The system of claim 1, wherein the processor is further enabled to:
determine a trigger-point for adjusting the ride-height system at a location prior to the deviance; and
wherein the adjustment to the ride-height system occurs when the vehicle reaches the trigger point.

5. The system of claim 1, wherein the processor is enabled to revert the ride-height system to a setting of the system prior to the adjustment responsive to a vehicle location being past a location associated with the deviance.

6. A system comprising:
a processor, of a vehicle, enabled to:
determine a route to a destination from a present location of the vehicle;
determine instances of surface deviances, along the route, prior to reaching one or more of the surface deviances, based on data indicating surface deviances along the route;
determine, for each instance of surface deviance, an adjustment to an adaptive ride-height system of the vehicle and a corresponding trigger location; and
responsive to the vehicle reaching a given trigger location, adjusting the adaptive ride-height system to change vehicle clearance in accordance with the determined adjustment corresponding to the given trigger location.

7. The system of claim 6, wherein the instances of surface deviances are determined based on relevancy parameters for the vehicle, defining surface deviance parameters relevant to the vehicle, and wherein the data indicating the surface deviances includes data usable for comparison to the relevancy parameters.

8. The system of claim 7, wherein the data usable for comparison includes at least one dimension of the surface deviance.

9. The system of claim 6, wherein the processor is further enabled to revert the ride-height system to a setting of the system prior to a given adjustment responsive to a vehicle location being past a location associated with a deviance for which the given adjustment was made.

10. The system of claim 6, wherein the processor is further enabled to:
determine that the adjustment for a given instance of a surface deviance will be insufficient based on a maximum adjustment compared to a dimension of the surface deviance; and
responsive to determining that the adjustment will be insufficient, adjust a route to avoid the surface deviance.

11. The system of claim 6, wherein the processor is further enabled to:
determine that the adjustment for a given instance of a surface deviance will be insufficient based on a maximum adjustment compared to a dimension of the surface deviance; and
alert a driver, including a recommended mitigation action, responsive to determine that the adjustment for a given instance of a surface deviance will be insufficient.

12. The system of claim 11, wherein the processor is enabled to:
determine a new trigger location for the surface deviance, projected to provide a driver of the vehicle with sufficient time to take mitigation action; and
provide the alert at least at the new trigger location including recommending the mitigation action.

13. The system of claim 12, wherein the mitigation action includes a vehicle maneuver.

14. The system of claim 12, wherein the mitigation action includes a recommended speed.

15. The system of claim 14, wherein the processor is further enabled to control the vehicle to travel at or below the recommended speed upon reaching the trigger location.

16. A system comprising:
a processor, of a vehicle, enabled to:
determine that a vehicle has reached a trigger location assigned for surface deviance impact mitigation based on a vehicle location compared the to the trigger location stored in memory along with a corresponding mitigation action;
automatically adjust a vehicle control system in a manner predefined as the mitigation action with respect to the trigger location to mitigate an effect of a known surface deviance on the vehicle as it travels over the surface deviance; and
revert the adjusted vehicle control system to a state of the system when the adjustment was made for the known surface deviance, responsive to the vehicle passing a location associated with the known surface deviance.

17. The system of claim 16, wherein the mitigation action includes adjusting a vehicle adjustable ride-height system.

18. The system of claim 16, wherein the mitigation action includes automatically controlling a vehicle speed until the vehicle passes a location associated with the known surface deviance.

19. The system of claim 16, wherein the processor is further enabled to:
receive a wireless alert about a new surface deviance, including a location of the new surface deviance and at least one dimension associated with the new surface deviance;
determine whether the vehicle will be impacted by the new surface deviance, based on one or more relevancy parameters stored in a memory of the vehicle; and
responsive to determining that the vehicle will be impacted, defining a trigger location for the new surface deviance including defining the corresponding mitigation action.

20. The system of claim 19, wherein the relevancy parameters include at least one of a current vehicle route, defining relevancy based on whether the vehicle will encounter the new surface deviance while traveling the route based on a location of the new surface deviance being on the route, or a minimum dimension, defining relevancy based on whether the at least one dimension is above a threshold defined by the minimum dimension.
